(19) United States
(12) Patent Application Publication
(10) Pub. No.: US 2023/0394508 A1
(43) Pub. Date: Dec. 7, 2023

(54) Preferred-Data Management Engine in a Customer Relationship Management Engine

(71) Applicants: Nathaniel Pave, Northbrook, IL (US); Jonathan David Gales, Seattle, WA (US)

(72) Inventors: Nathaniel Pave, Northbrook, IL (US); Jonathan David Gales, Seattle, WA (US)

(21) Appl. No.: 17/834,693

(22) Filed: Jun. 7, 2022

(51) Int. Cl. G06Q 30/02; G06Q 30/00

(52) U.S. Cl. CPC G06Q 30/0201; G06Q 30/016

(57) ABSTRACT

Methods, systems, and computer storage media for providing preferred-data recommendations using a preferred-data management engine in a customer relationship management system. The preferred-data recommendation can be specific user data that is programmatically extracted from one or more data sources associated with the user. For example, the recommendation can be a preferred name (e.g., “nickname”) for a user that is computed from a combination of preferred-data source objects. In operation, a preferred-data management engine accesses contact data from a contact list. The contact data is associated with a plurality preferred-data source objects (e.g., email address, full name, social media URL, voicemail recording). The preferred-data source objects are parsed using one or more parsing operations associated with a preferred-data computation engine. Based on parsing the plurality of preferred-data source objects using the engine, a determination of preferred-data associated with the plurality preferred-data source objects. The preferred-data is communicated as a preferred-data recommendation.

### BACKGROUND

Many corporations rely on customer relationship management (CRM) systems to manage interactions with customers. CRM systems compile data from a range of different communication channels, including a company's website, telephone, email, live chat, marketing materials and more recently, social media. CRM systems allow businesses to learn more about their target audiences and how to best cater for their needs, thus retaining customers and driving sales growth. Sales associates can use CRM systems to contact customers. In particular, a CRM system can support maintaining a contacts-list along with relationships and interactions with contacts. For example, a sales associate can make a phone call to a contact, or email a contact based on contact information in the contacts-list.

Conventional CRM systems are not configured with a computing infrastructure and logic to assist managing (e.g., deriving, arranging, visualizing, and communicating) contacts-list data. A contact may be identified by a first name in a contacts-list; however their first name may not be their preferred name. For example, Daniel Johnson may have email address “Dan_Johnson@email.com” or “DJ@email.com” and may prefer to go by “Dan” or “DJ”, respectively. Without the accurate first name (or other accurate preferred information for a contact), current CRM systems operate inefficiently in supporting computing operations and interfaces. As such, a more comprehensive CRM system—with an alternative basis for performing carbon emissions management operations—can improve computing operations and interfaces for the CRM system.

### SUMMARY

Various aspects of the technology described herein are generally directed to systems, methods, and computer storage media, for among other things, providing preferred-data recommendations (“recommendations”) using a preferred-data management engine (“preferred-data engine”) in a customer relationship management system. The recommendation can be specific user data that is programmatically extracted from one or more data sources associated with the user. For example, the recommendation can be a preferred name (e.g., “Dan”) for a user, the preferred name is computed based on processing a combination of the user's email address (e.g., Dan_Johnson@email.com), full name from contact data (e.g., Daniel Oliver Johnson), and social media URL: (e.g., www.asocialnetwork.com/DanJohson).

In operation, a preferred-data management engine accesses contact data of a contact list. The contact data is associated with a plurality preferred-data source objects (e.g., email address, full name, social media URL). The preferred-data source object is parsed using one or more parsing operations associated with a preferred-data computation engine. Based on parsing the plurality of preferred-data source objects, a determination of preferred-data (e.g., a preferred-name of a user associated with the email address or social media profile) is made. The preferred-data is communicated as a preferred-data recommendation.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The technology described herein is described in detail below with reference to the attached drawing figures, wherein:

FIGS. 1A and 1B are block diagrams of an exemplary customer relationship management system with a preferred-data management engine, in which embodiments described herein may be employed;

FIGS. 2A and 2B are block diagrams of an exemplary customer relationship management system with a preferred-data management engine, in which embodiments described herein may be employed;

FIG. 3 is a flow diagram showing an exemplary method for implementing a customer relationship management system with a preferred-data management engine, in accordance with embodiments described herein;

FIG. 4 is a flow diagram showing an exemplary method for implementing a customer relationship management system with a preferred-data management engine, in accordance with embodiments described herein;

FIG. 5 is a flow diagram showing an exemplary method for implementing a customer relationship management system with a preferred-data management engine, in accordance with embodiments described herein;

FIG. 6 provides a block diagram of an exemplary distributed computing environment suitable for use in implementing aspects of the technology described herein; and

FIG. 7 is a block diagram of an exemplary computing environment suitable for use in implementing aspects of the technology described herein.

### DETAILED DESCRIPTION

### Overview

By way of background, a Customer Relationship Management (CRM) can include a customer relationship management computing environment that supports a business or other organization in administering interactions with customers. A customer relationship management system may integrate and automate sales, marketing, and customer support. For example, sales associates can use a CRM system to contact customers. In particular, a CRM system can support maintaining a contacts-list along with relationships and interactions with contacts. For example, a sales associate can make a phone call to a contact, or email a contact based on contact information in the contacts-list. As such, the functionality described herein can support a customer relationship management system's capacity to compile data from a range of different communication channels in order to learn about target audiences and how best to cater to their needs to drive growth and retain customers.

Conventional customer relationship management systems are limited in their capacity to manage (e.g., derive, arrange, visualize, and communicate) contacts-list data. In particular, a conventional customer relationship management systems may rely on some manual and semi-automated techniques for managing preference data for a contact. For example, a sales associate—using a CRM system—can manually identify a shortened name or nickname for a contact (e.g., through social media or social networking platforms) and manually update the contact's information in a contact's list. Or, a social networking platform may provide an interface for a user to enter their preferred contact information (e.g., nickname, pronunciation), such that, the preferred contact information is stored as part of a user's contact information. However, this preferred contact information is not readily available via a customer relationship management system when a sales associate is attempting to contact the user. Moreover, conventional techniques can be time-consuming and have limited adoption because of the additional steps needed by either the user/contact or sales associate to identify and store the preferred contact data. As such, a more comprehensive CRM system—with an alternative basis for performing preferred-data management operations—can improve computing operations and interfaces for the preferred-data in a CRM system.

Embodiments of the present disclosure are directed to systems, methods, and computer storage media, for among other things, providing preferred-data recommendations (“recommendations”) using a preferred-data management engine (“preferred-data engine”) in a customer relationship management system. The preferred-data recommendation can be specific user data that is programmatically extracted from one or more data sources associated with the user. For example, the recommendation can be a preferred name (e.g., “nickname”) for a user that is computed from a combination of preferred-data source objects.

The recommendation can be associated with parsing operations based on a preferred-data computation model of the customer relationship management system. The parsing operations refer to a process of analyzing contact data (including a string of symbols, either in natural language, computer languages, or in data structures) via a preferred-data computation engine to generate recommendations. For example, the parsing operations execute different algorithms and techniques (e.g., parsing logic) of the preferred-data computation engine to identify preferred names (i.e., preferred-data recommendation) in an email or Uniform Resource Locator (URL) associated with a contact. The preferred-data computation engine can process different types of contact data to generate recommendations and corresponding preferred-data interface elements and user interaction contexts. The preferred-data recommendations can be automatically adopted in some instances, while in other instances, the preferred-data recommendations can be provided for manual review prior to being communicated via a customer relationship management interface with the preferred-data interface elements.

A preferred-data computation engine—having a parsing logic (i.e., parsing operations) identifying preferred-data source objects and programmatically extracting preferred-data—is configured in a preferred-data management engine of a customer relationship management system. The preferred-data source objects are used compute preferred-data to make preferred-data recommendations associated with contacts in a contacts-list. The preferred-data recommendation can be caused to be displayed via a preferred-data interface that include interface elements and features that support presenting the preferred-data recommendations via a preferred-data management engine client on a client.

As such, a customer relationship management system can operate more efficiently with regard to identify preferred-data for a contact. Advantageously, providing preferred-data is automated based on a combination data structures, operations, and interfaces associated with a preferred-data management engine. In particular, specific types of contact data are identified, retrieved, or computed as preferred-data source objects. A parsing logic is used to systematically analyze the preferred-data source objects and programmatically extract or compute preferred-data. Preferred-data can be provided as preferred-data recommendations for a contact in via different interfaces in different contexts. For example, the preferred-data recommendation can be provided to a user via a customer relationship management system to facilitate their access to the preferred contact information of the contact.

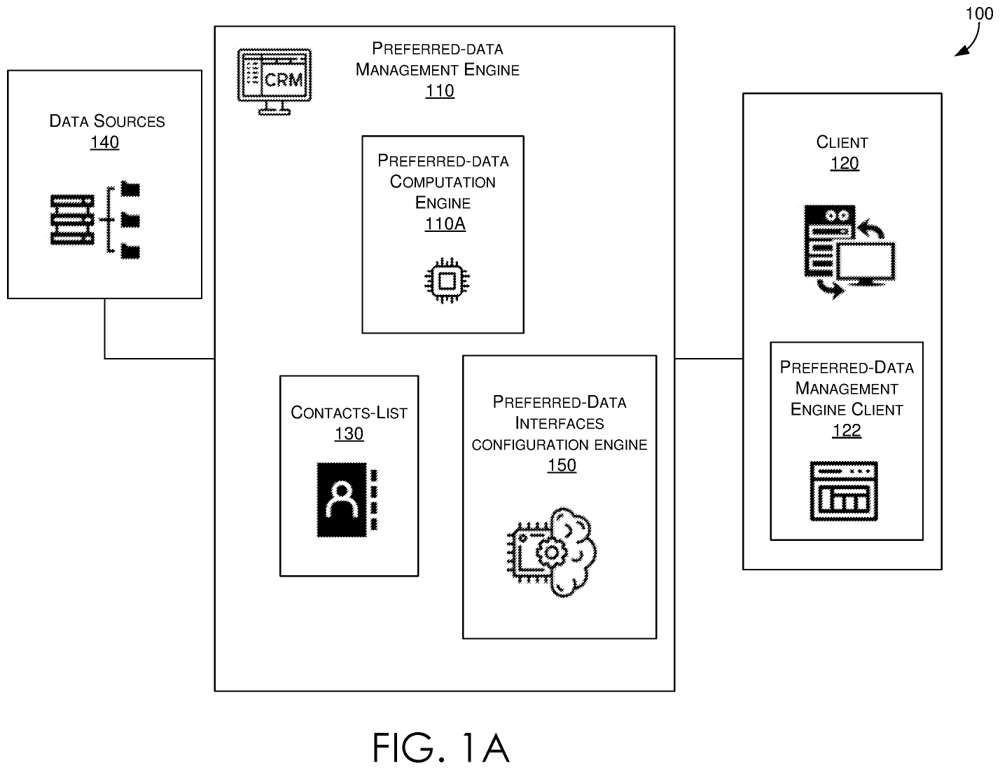

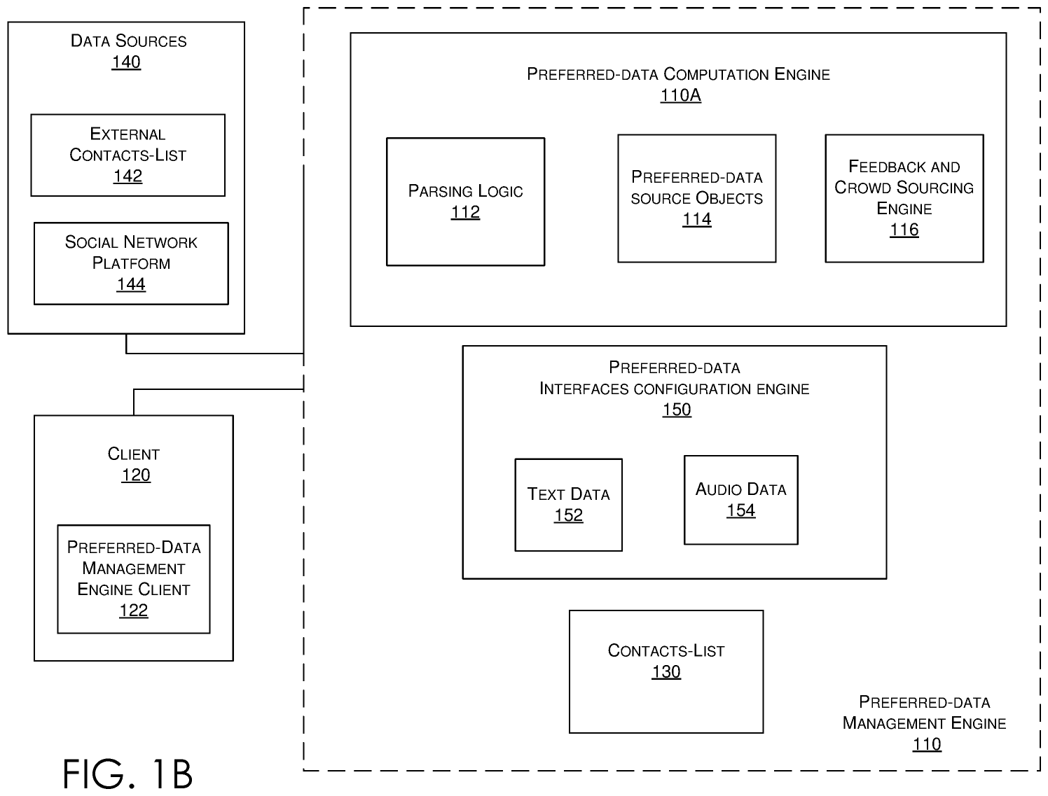

Aspects of the technical solution can be described by way of examples and with reference to FIGS. 1A and 1B. FIG. 1A illustrates a customer relationship management system 100 including preferred-data management engine 110; preferred-data computation engine 110A, client 120 including preferred-data management engine client 122; contacts-list 130; data sources 140, and preferred-data interfaces configuration engine 150.

With reference to FIG. 1B, FIG. 1B illustrates aspects of the preferred-data management engine 110. FIG. 1B includes preferred-data computation engine 110A having parsing logic 112, preferred-data source objects 114; feedback and crowd sourcing engine 116; client 120 having preferred-data management client 122, data sources 140 including external contacts-list 142 and social network platform 144, preferred-data interfaces configuration engine 150 having text data 152 and audio data 154.

At a high level, a preferred-data management engine (e.g., preferred-data management engine 110) accesses contact data that includes a plurality of contact information entries associated with a contact. The plurality of contact information entries include one or more name entries. For example, a telemarking contacts-list can include the a contact's residence address, email address, and a first name, middle, and last name. Using a preferred-data computation engine (e.g., preferred-data computation engine 110A) the contact data is parsed, where parsing comprises programmatically extracting preferred-data from a plurality of preferred-data source objects identified in the contact data. For example, parsing contact data with first name: Daniel; last name; Johnson; email: “DJ@email.com” and inferring a preferred name (i.e., preferred-data): ‘DJ’. Inferring the preferred name ‘DJ’ based on a parsing logic that identifies ‘D’ and ‘J’ as first initials of the first name and last name and matching that to the first portion of the email address prior to the “@” symbol. Further matching ‘DJ’ as a known nickname in a nickname database.

A preferred-data interfaces configuration engine (e.g., preferred-data interfaces configuration engine 150) supports communicating, for presentation on a preferred-data interface, the preferred-data as a preferred-data recommendation that is a predicted alternative for the one or more name entries. The preferred-data interfaces configuration engine operates with a client (e.g., client 120) and a preferred-data management engine client (e.g., preferred-data management engine client 122) to causes presentation and display of preferred-data and correspond preferred-data interface elements.

In another example, contact data can include a first name: Daniel; and last name: Johnson. An email (i.e., a first preferred-data source object) is Dan_Johnson@email.com. A social medial URL (i.e., a second preferred-data source object is www.asocialnetwork.com/DanJonson A voice recording (i.e., a third preferred-data source object) is a voicemail or preferred-pronunciation recording includes audio containing words “Dan Johnson.” One or more of the data sources (e.g., data source 140) can include contact data having a preferred-data source object that can be parsed to extract “Dan” and “Johnson” as portions of the preferred-data source object.

Data sources and can be associated with contact data Contact data refers to can refer to contact information associated with different important contact categories. For example, a business or organization may have contact information for customers, employees, and vendors and an individual may have contact information for a friends and family. In this way, contact data can be associated different types of entities (i.e., business, organization, or individual). Contact data can include various information such as name, address, phone, email, social media handle, social media URL.

Contact data can be associated with a plurality of contacts whose corresponding contact information is provided in the contact data. Contact data entries, values, storage, configuration, data type can be different based on a data source (e.g., external contact-list 142 and social network platform 144) of the contact data. For example, contact data from a social networking data source can be different contact data from business. Data sources having different types of contact data are contemplated with embodiments described herein.

Contact data can include name entries as contact information. Name entries can include text or audio name entries. Text entries can include a first name, middle name, last name, other name, and preferred name. Name entries can include graphics-based entries (e.g., photographs, signature blocks, etc.) Name entries can also include an audio recording of one or more name of the contact. Other variations and combination of name entries in contact information are contemplated with embodiments described herein. Contact data can be associated with a contacts-list. For example, a contacts-list for a particular product or service can be generated. Based on the contacts-list, contact data for the contact list is retrieved. The contact data associated with the contacts-list can be retrieved from a plurality of data sources.

Types of contact data can be identified as preferred-data source objects. Preferred-data source objects are retrieved from contact data. The preferred-data source objects can be in different formats (e.g., text, audio, graphical). Preferred-data source objects can refer to contact information or a portion of contact information that is parsed to programmatically extract preferred-data. Preferred-data can refer to an a portion of a preferred-data source object that can be used to make an inference or logically determine an alternative, substitute, or nickname for one or more name entries in contact data.

Certain types of contact information are known to include preferred-data and others can support a strong inference that a portion of the preferred-data source object is preferred-data. For example, an email address or social media account identifier (e.g., URL) can be a preferred-data source object, where the preferred-data source object is parsed to identify a portion of the preferred-data source object (e.g., a substring). A plurality of parsing operations can be used to programmatically extract a portion of the preferred-data source object. Using the portion of the preferred-data object, additional operations can be performed to infer or logically determine that the portion of the preferred-data source object that is preferred-data to operate as an alternative, substitute, or nickname for one or more name entries in contact data.

Parsing the preferred-data source objects can be based different parsing logic. Parsing logic can include identifying one or more delimiters that precede or follow the embedded-names in preferred-data source object. Based on identifying the delimiter, a portion of the preferred-data source object is further parsed to identify an embedded-name. The embedded-name can be identified using different techniques. For example, the embedded-name can be compared to name entries in the contact data and an inference can be made that the embedded name is a preferred name of the contact. In this way, the parsing logic generally operates to systematically identify portion of preferred-data source object that have a likelihood of being an embedded-name based on evaluating a known structure of the preferred-data source object and extracting the portion of the known structure of the preferred-data source object that would likely include the embedded-name. The parsing logic can also use known structure—including known email variations, such as for technical support—to efficiently exclude certain types of preferred-data source objects from parsing. For example, emails: admin@email.com or contactus@email.com can be excluded from parsing operations. Other variations and combinations of parsing logic for effectively and efficiently identifying embedded-names in preferred-data source objects are contemplated with embodiments described herein.

Operationally, the preferred-data management engine is responsible for processing contact data. The preferred-data management engine accesses contact data. The contact data identifies contact information associated with a contact. The preferred-data management engine can retrieve the contact data from a plurality of data sources based on a contact list. The contact list includes a plurality of contacts. For example, the contact list can be accessed and the preferred-data management engine initiates operations to retrieve contact data associated with the plurality of contacts of contacts in the contact list. In this way, parsing operations can include retrieving different actual name entries (e.g., first name, last name, middle name, other name, or a preferred name) from contact data. Identifying one or more preferred-data source objects from the contact data, where a preferred-data source object has a likelihood of having a name (i.e., embedded-name) embedded in the preferred-data source object.

An embedded-name that is identified in a preferred-data source object is compared to the different name entries to determine whether the embedded-name is preferred-data (i.e., a portion of a preferred-data source object that can be used to make an inference or logically determine alternative, substitute, or nickname for one or more name entries in contact data). Comparing the embedded-named to the name entries can evaluate whether the embedded-name is a substring of a name entry. Comparing the embedded-name to the name entries can also include processing the embedded-name and a name entry using a name-nickname database that includes name-nickname combinations.

Different methods can be used to generate a confidence score that quantifies a likelihood that the embedded-name is preferred-data. For example, if multiple preferred-data source objects include the same embedded-name, the embedded-name will have a high score. If a reputable data source includes a preferred-data source object with the embedded-name, that can be a high score. If there exists different embedded-names that are matched to the same name entry, that could be a medium or low score. Overall, if a plurality of signals support selecting an embedded-name as preferred-data then the confidence score can be in the medium to high range, and conversely, if a limited number of signals support selecting the embedded-name as preferred-data, then the confidence score can be in the is medium to low range. It is contemplated that if there exists alternative preferred-data, the alternatives can be processed and presented as options via a preferred-data interface of a customer relationship management engine.

The preferred-data interface configuration engine (e.g., preferred-data interfaces configuration engine 150) can be used to support functionality associated with provide preferred-data via preferred-data interfaces and communicating with clients having preferred-data management engine clients. Preferred-data interfaces and preferred-data interface elements allow effective operation and control by users while the preferred-data management engine simultaneously performs computing operations. Interface data can include graphical user interfaces that allow users to interact with the CRM system through graphical user interface elements.

The preferred-data management engine client 122 can provide a preferred-data interface that support causing display of the preferred-data as a preferred-data recommendation that is a predicted alternative for one or more name entries. Causing display of the preferred-data as a preferred-data recommendation can include presenting a confidence indicator associated with a confidence score that quantifies a likelihood that the embedded-name is preferred-data. Causing display of preferred-data can include presenting a preferred-data audio interface element, where a selection of the preferred-data audio interface element causes audio playback of a predicted alternative for the one or more entries. For example, the preferred-data audio element can be selected to cause playback of the predicted alternative.

The preferred-data management engine client can operate on client device associated with a CRM or other computing system to provide preferred-data interfaces associated with feedback or crowd sourcing functionality (e.g., via feedback and crowd sourcing engine 116). The feedback can be based on user information that can be used to verify or change the preferred-data associated with contact data. For example, upon making a call to a contact, a user may determine that the preferred-data was incorrect and update the preferred-data via the preferred-data interface. Or, the user can provide feedback indicating the preferred-data was correctly inferred such that the preferred-data can be identified as user-verified in the system. The preferred-data interface can operate with the feedback and crowd source engine 116 to provide an interface for manual intervention in updating preferred data and providing signals for negative or positive automated identification of preferred-data. The feedback and crowd sourcing engine 116 is also associated with graphical user interface elements that are provided for user interactions with the preferred-data management engine to facilitate the functionality of the feedback and crowd sourcing engine. A feedback or crowdsourcing interface can allow for recording—directly (from contact) or indirectly (from sales associate)—a pronunciation of a name and the name can be identified as an audio-based crowd-sourced preferred-data, and stored as part of a contact profile. For example, during a recorded call, a contact may respond and provide their preferred name (and pronunciation) and the recording can be stored as part of their contact data. Other variations and combinations of feedback and crowd sourcing functionality are contemplated with embodiments described herein.

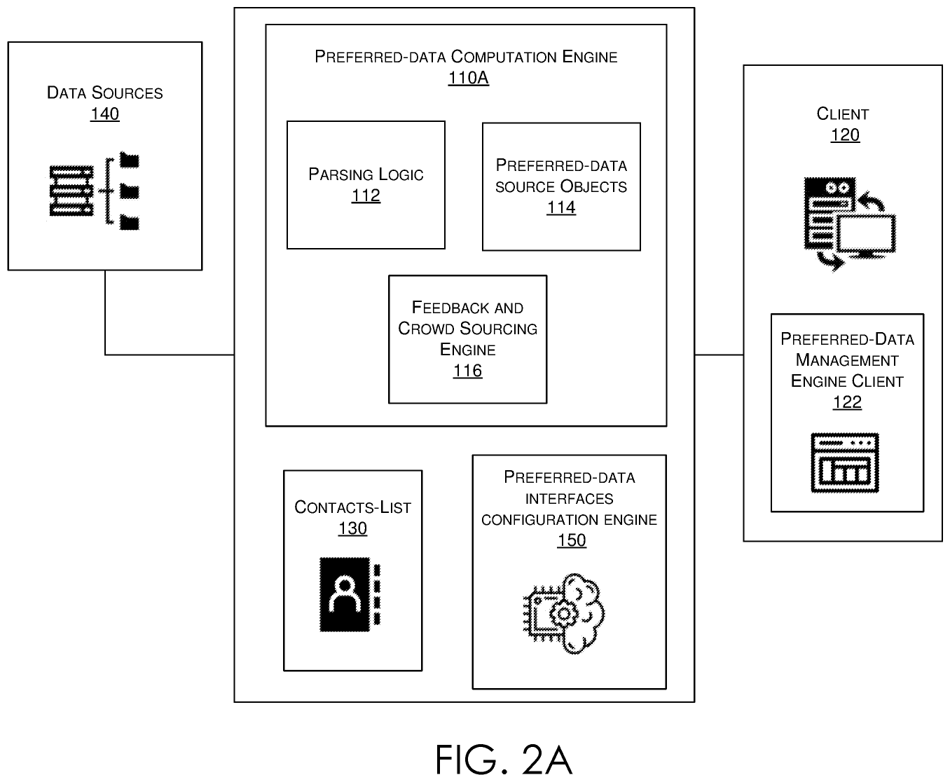

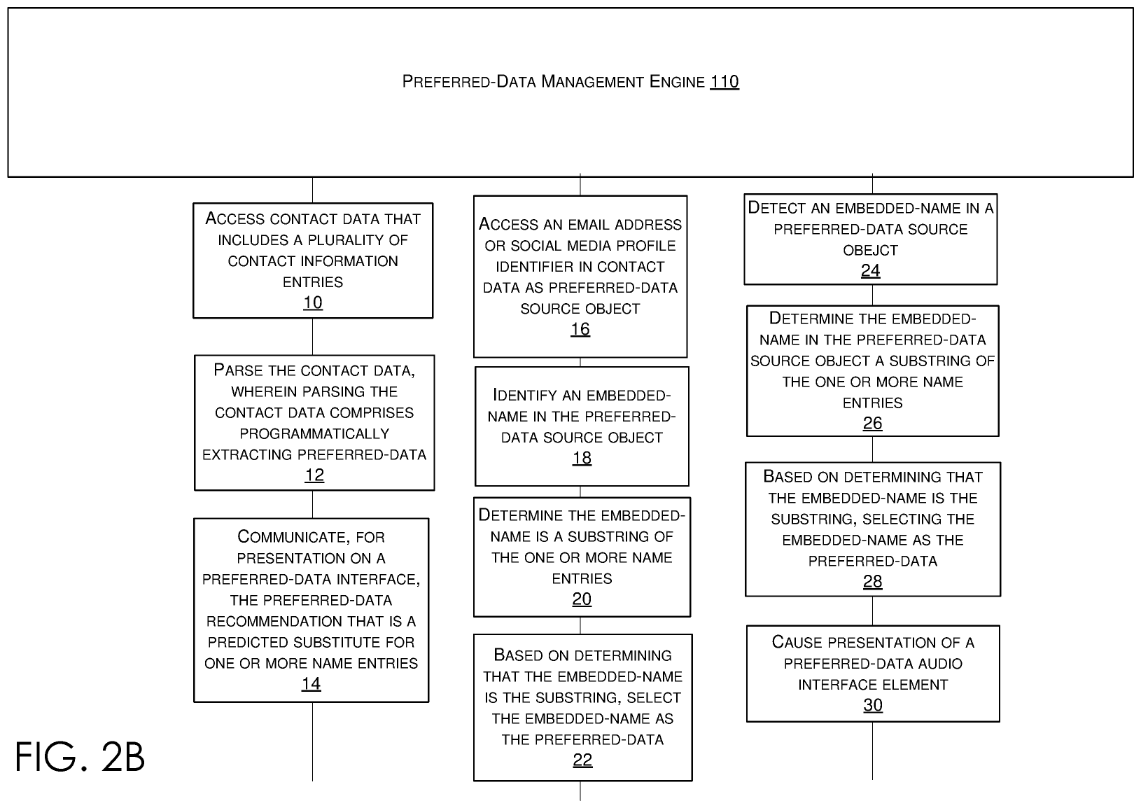

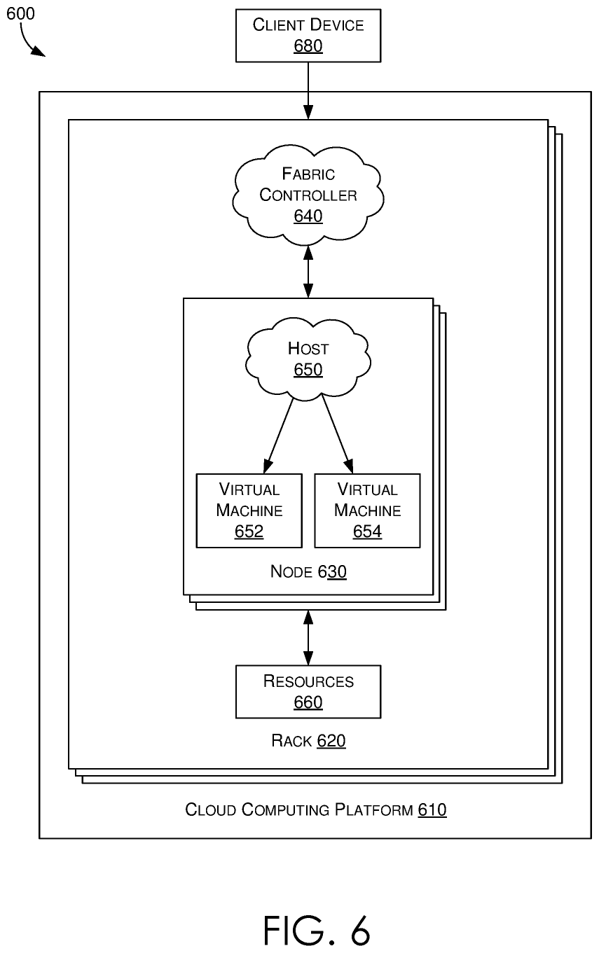

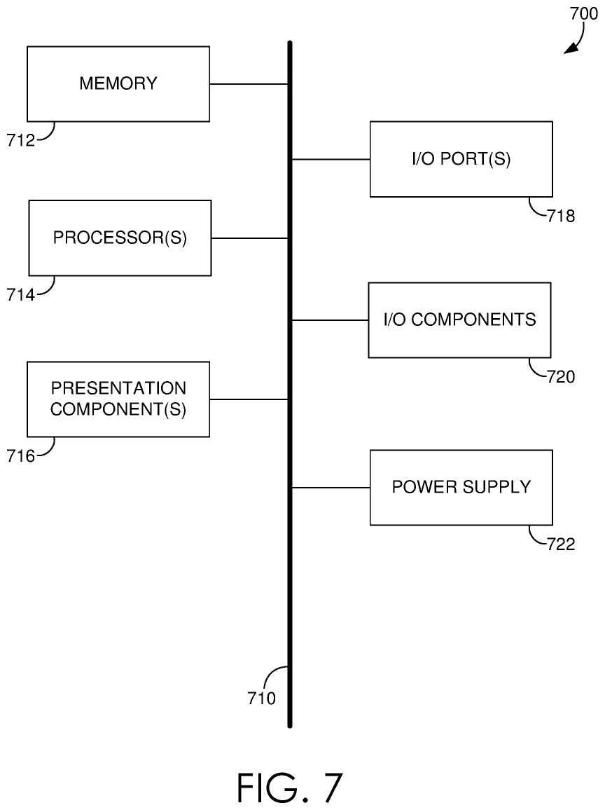

Aspects of the technical solution can be described by way of examples and with reference to FIGS. 2A and 2B. FIG. 2A is a block diagram of an exemplary technical solution environment, based on example environments described with reference to FIGS. 6 and 7 for use in implementing embodiments of the technical solution are shown. Generally the technical solution environment includes a technical solution system suitable for providing the example customer relationship management system 100 in which methods of the present disclosure may be employed. In particular, FIG. 2A shows a high level architecture of the customer relationship management system 100 in accordance with implementations of the present disclosure. Among other engines, managers, generators, selectors, or components not shown (collectively referred to herein as “components”), the technical solution environment of customer relationship management system 100 corresponds to FIGS. 1A and 1B.

With reference to FIG. 2A, FIG. 2A illustrates a customer relationship management system 100 FIG. 2A includes preferred-data computation engine 110A having parsing logic 112, preferred-data source objects 114; feedback and crowd sourcing engine 116; client 120 having preferred-data management client 122, data sources 140 including external contacts-list 142 and social network platform 144, preferred-data interfaces configuration engine 150 having text data 152 and audio data 154.

With reference to FIG. 2B, FIG. 2B illustrates a preferred-data management engine and a preferred-data management engine client. The preferred-data management engine supports preferred-data recommendations (“recommendations”) using a preferred-data management engine (“preferred-data engine”) in a customer relationship management system based on a plurality of operations described in corresponding block in FIG. 2B. At block, access contact data that includes a plurality of contact information entries. At block 12, parse the contact data, parsing the contact data comprises programmatically extracting preferred-data. At block 14, communicate, for presentation on a preferred-data interface, the preferred-data recommendation that is a predicted alternative for one or more name entries. At block 16, access an email address or social media profile identifier in contact data as preferred-data source object. At block 18, identify an embedded-name in the preferred-data object source object. At block 20, determine the embedded-name is a substring of the one or more name entries. At block 22, based on determining that the embedded-name is the substring, select the embedded-name as the preferred-data.

At block 24, detect an embedded-name is a preferred-data source object. At block 26, determine the embedded-name in the preferred-data source object as a substring of the one or more name entries. At block 28, based on determining that the embedded-name is the substring, select the embedded-name as the preferred-data. At block 30, cause presentation of a preferred-data audio interface element, wherein a selection of the preferred-audio interface element causes audio playback of a predicted alternative of the one or more name entries.

### Exemplary Methods

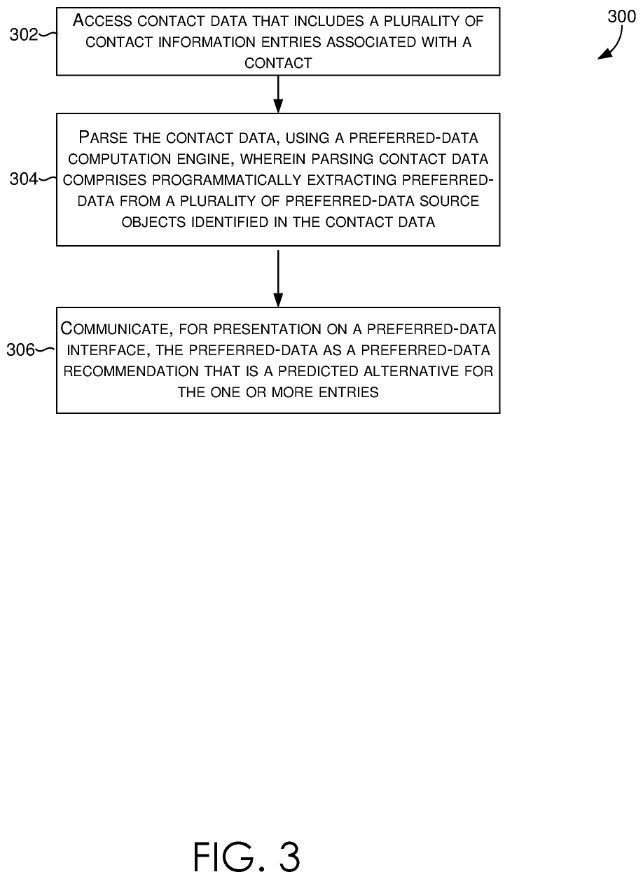

With reference to FIGS. 3, 4 and 5, flow diagrams are provided illustrating methods for providing preferred-data recommendations (“recommendations”) using a preferred-data management engine (“preferred-data engine”) in a customer relationship management system. The methods may be performed using the customer relationship management system described herein. In embodiments, one or more computer-storage media having computer-executable or computer-useable instructions embodied thereon that, when executed, by one or more processors can cause the one or more processors to perform the methods (e.g., computer-implemented method) in the customer relationship management system (e.g., a computerized system or computing system).

Turning to FIG. 3, a flow diagram is provided that illustrates a method 300 providing preferred-data recommendations (“recommendations”) using a preferred-data management engine (“preferred-data engine”) in a customer relationship management system. At block 302, access contact data that includes a plurality of contact information entries associated with a contact. The plurality of contact information entries include one or more name entries. At block 304, parse the contact data using a preferred-data computation engine. Parsing the contact data comprises programmatically extracting preferred-data from a preferred-data source object identified in the contact data. At block 306, communicate the preferred-data as a preferred-data recommendation that is a predicted alternative for the one or more name entries.

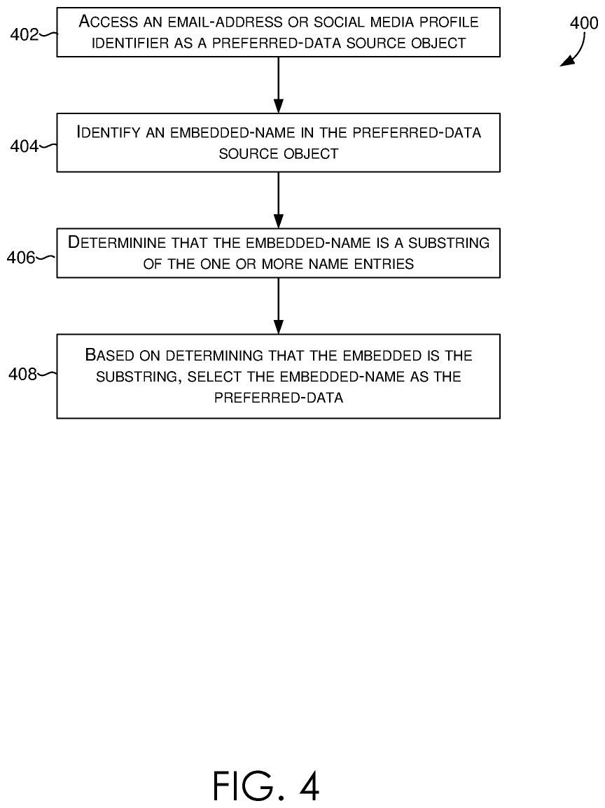

Turning to FIG. 4, a flow diagram is provided that illustrates a method 400 providing preferred-data recommendations (“recommendations”) using a preferred-data management engine (“preferred-data engine”) in a customer relationship management system. At block 402, access an email address or social media account identifier in contact data as a preferred-data source object. At block 404, identify an embedded-name in the preferred-data source object. At block 406, determine that the embedded-name is a substring of one or more name entries in the contact data. At block 408, based on determining that the embedded-name is the substring, select the embedded-name as preferred-data.

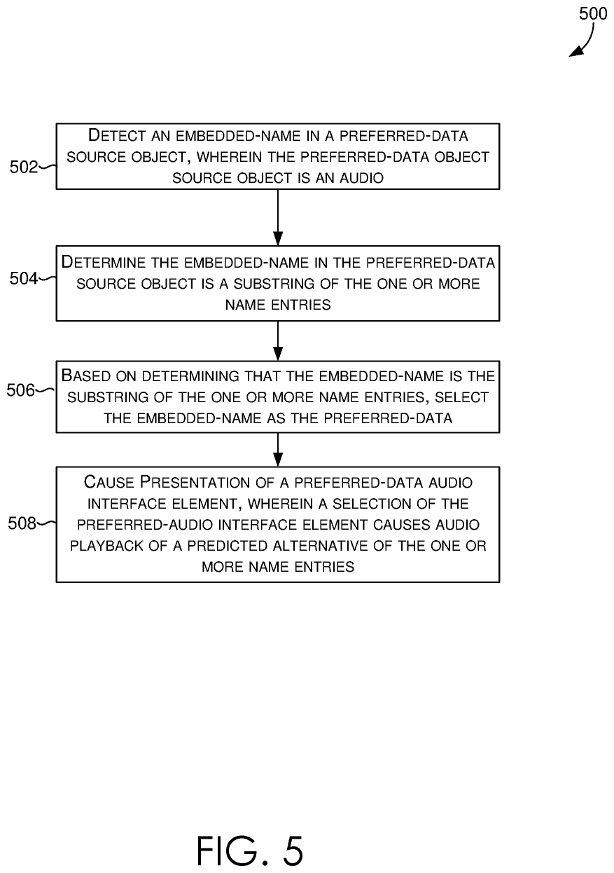

Turning to FIG. 5, a flow diagram is provided that illustrates a method 500 providing preferred-data recommendations (“recommendations”) using a preferred-data management engine (“preferred-data engine”) in a customer relationship management system. At block 502, detect an embedded name in a preferred-data source object. The preferred-data source object is audio. At block 504, determine the embedded-name in the preferred-data source object is a substring of one or more name entries. At block 506, based determining that the embedded-name is the substring, select the embedded-name as the preferred-data. At block 508, causing presentation of a preferred-data audio interface element, wherein a selection of the preferred-audio interface element cause playback of a predicted alternative of the one or more name entries that corresponds to the preferred-data.

### Example Distributed Computing System Environment

Referring now to FIG. 6, FIG. 6 illustrates an example distributed computing environment 600 in which implementations of the present disclosure may be employed. In particular, FIG. 6 shows a high level architecture of an example cloud computing platform 610 that can host a technical solution environment, or a portion thereof (e.g., a data trustee environment). It should be understood that this and other arrangements described herein are set forth only as examples. For example, as described above, many of the elements described herein may be implemented as discrete or distributed components or in conjunction with other components, and in any suitable combination and location. Other arrangements and elements (e.g., machines, interfaces, functions, orders, and groupings of functions) can be used in addition to or instead of those shown.

Data centers can support distributed computing environment 600 that includes cloud computing platform 610, rack 620, and node 630 (e.g., computing devices, processing units, or blades) in rack 620. The technical solution environment can be implemented with cloud computing platform 610 that runs cloud services across different data centers and geographic regions. Cloud computing platform 610 can implement fabric controller 640 component for provisioning and managing resource allocation, deployment, upgrade, and management of cloud services. Typically, cloud computing platform 610 acts to store data or run service applications in a distributed manner. Cloud computing infrastructure 610 in a data center can be configured to host and support operation of endpoints of a particular service application. Cloud computing infrastructure 610 may be a public cloud, a private cloud, or a dedicated cloud.

Node 630 can be provisioned with host 650 (e.g., operating system or runtime environment) execution a defined software stack on node 630. Node 630 can also be configured to perform specialized functionality (e.g., compute nodes or storage nodes) within cloud computing platform 610. Node 630 is allocated to run one or more portions of a service application of a tenant. A tenant can refer to a customer utilizing resources of cloud computing platform 610. Service application components of cloud computing platform 610 that support a particular tenant can be referred to as a tenant infrastructure or tenancy. The terms service application, application, or service are used interchangeably herein and broadly refer to any software, or portions of software, that run on top of, or access storage and compute device locations within, a datacenter.

When more than one separate service application is being supported by nodes 630, nodes 630 may be partitioned into virtual machines (e.g., virtual machine 652 and virtual machine 654). Physical machines can also concurrently run separate service applications. The virtual machines or physical machines can be configured as individualized computing environments that are supported by resources 660 (e.g., hardware resources and software resources) in cloud computing platform 610. It is contemplated that resources can be configured for specific service applications. Further, each service application may be divided into functional portions such that each functional portion is able to run on a separate virtual machine. In cloud computing platform 610, multiple servers may be used to run service applications and perform data storage operations in a cluster. In particular, the servers may perform data operations independently but exposed as a single device referred to as a cluster. Each server in the cluster can be implemented as a node.

Client device 680 may be linked to a service application in cloud computing platform 610. Client device 680 may be any type of computing device, which may correspond to computing device 600 described with reference to FIG. 6, for example, client device 680 can be configured to issue commands to cloud computing platform 610. In embodiments, client device 680 may communicate with service applications through a virtual Internet Protocol (IP) and load balancer or other means that direct communication requests to designated endpoints in cloud computing platform 610. The components of cloud computing platform 610 may communicate with each other over a network (not shown), which may include, without limitation, one or more local area networks (LANs) and/or wide area networks (WANs).

### Example Computing Environment

Having briefly described an overview of embodiments of the present invention, an example operating environment in which embodiments of the present invention may be implemented is described below in order to provide a general context for various aspects of the present invention. Referring initially to FIG. 7 in particular, an example operating environment for implementing embodiments of the present invention is shown and designated generally as computing device 700. Computing device 700 is but one example of a suitable computing environment and is not intended to suggest any limitation as to the scope of use or functionality of the invention. Neither should computing device 700 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc. refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 7, computing device 700 includes bus 710 that directly or indirectly couples the following devices: memory 712, one or more processors 714, one or more presentation components 716, input/output ports 718, input/output components 720, and illustrative power supply 722. Bus 710 represents what may be one or more buses (such as an address bus, data bus, or combination thereof). The various blocks of FIG. 7 are shown with lines for the sake of conceptual clarity, and other arrangements of the described components and/or component functionality are also contemplated. For example, one may consider a presentation component such as a display device to be an I/O component. Also, processors have memory. We recognize that such is the nature of the art, and reiterate that the diagram of FIG. 7 is merely illustrative of an example computing device that can be used in connection with one or more embodiments of the present invention. Distinction is not made between such categories as “workstation,” “server,” “laptop,” “hand-held device,” etc., as all are contemplated within the scope of FIG. 7 and reference to “computing device.”

Computing device 700 typically includes a variety of computer-readable media. Computer-readable media can be any available media that can be accessed by computing device 700 and includes both volatile and nonvolatile media, removable and non-removable media. By way of example, and not limitation, computer-readable media may comprise computer storage media and communication media.

Computer storage media include volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 700. Computer storage media excludes signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 712 includes computer storage media in the form of volatile and/or nonvolatile memory. The memory may be removable, non-removable, or a combination thereof. Exemplary hardware devices include solid-state memory, hard drives, optical-disc drives, etc. Computing device 700 includes one or more processors that read data from various entities such as memory 712 or I/O components 720. Presentation component(s) 716 present data indications to a user or other device. Exemplary presentation components include a display device, speaker, printing component, vibrating component, etc.

I/O ports 718 allow computing device 700 to be logically coupled to other devices including I/O components 720, some of which may be built in. Illustrative components include a microphone, joystick, game pad, satellite dish, scanner, printer, wireless device, etc.

### Additional Structural and Functional Features of Embodiments of the Technical Solution

Having identified various components utilized herein, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software, as described below. For instance, various functions may be carried out by a processor executing instructions stored in memory. As such, other arrangements and elements (e.g., machines, interfaces, functions, orders, and groupings of functions) can be used in addition to or instead of those shown.

Embodiments described in the paragraphs below may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of embodiments of the invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” Further the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion above, embodiments of the present invention are described with reference to a distributed computing environment; however the distributed computing environment depicted herein is merely exemplary. Components can be configured for performing novel aspects of embodiments, where the term “configured for” can refer to “programmed to” perform particular tasks or implement particular abstract data types using code. Further, while embodiments of the present invention may generally refer to the technical solution environment and the schematics described herein, it is understood that the techniques described may be extended to other implementation contexts.

Embodiments of the present invention have been described in relation to particular embodiments which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects hereinabove set forth together with other advantages which are obvious and which are inherent to the structure.

It will be understood that certain features and sub-combinations are of utility and may be employed without reference to other features or sub-combinations. This is contemplated by and is within the scope of the claims.

What is claimed is:

1. A computerized system comprising:
one or more computer processors; and
computer memory storing computer-useable instructions that, when used by the one or more computer processors, cause the one or more computer processors to perform operations comprising:
accessing, at a preferred-data management engine, contact data that includes a plurality of contact information entries associated with a contact, wherein the plurality of contact information entries include one or more name entries;
parsing the contact data, using a preferred-data computation engine, wherein parsing the contact data comprises programmatically extracting preferred-data from a plurality of preferred-data source objects identified in the contact data; and
communicating, for presentation on a preferred-data interface, the preferred-data as a preferred-data recommendation that is a predicted alternative for the one or more name entries.

2. The system of claim 1, wherein the contact data is retrieved from a plurality of sources based on a contact list of a plurality contacts including the contact, the contact list is provided to trigger retrieving the contact data from the plurality of data sources associated with a plurality of entities.

3. The system of claim 1, wherein parsing the contact data to programmatically extract preferred-data comprises:
accessing an email address or a social media identifier in the contact data as a preferred-data source object;
identifying an embedded-name in the preferred-data source object;
determining that the embedded-name is a substring of the one or more name entries; and
based on determining that the embedded-name is the substring, selecting the embedded-name as the preferred-data.

4. The system of claim 3, wherein identifying the embedded-name in the preferred-data source object is based on identifying one or more known delimiters that precede or follow the embedded-names in the preferred-data source object; and
wherein selecting the embedded name as the preferred-data is further based on processing the embedded-name and the one or more name entries via a name-nickname database that include name-nickname combinations.

5. The system of claim 1, wherein parsing the contact data to programmatically extract preferred-data comprises:
detecting an embedded-name in a preferred-data source object, wherein the preferred-data source object is an audio;
determining the embedded-name in the preferred-data source object is a substring of the one or more name entries; and
based on determining that the embedded-name is a substring, selecting the embedded-name as the preferred-data.

6. The system of claim 1, wherein parsing the contact data comprises performing each of the following parsing operations including:
retrieving the one or more name entries comprising one or more of the following: a first name, last name, middle name, other name, or preferred name;
apply a parsing logic to the preferred-data source object, wherein the preferred-data source object a contact information entry with a likelihood of having an embedded name or data associated with computing an embedded-name;
comparing the embedded-name to a first name, last name, middle name, other name, or preferred name; and
generating confidence score that quantifies a likelihood that the embedded-name is the preferred-data.

7. The system of claim 1, wherein the preferred-data interface is associated with a customer relationship management system, wherein causing presentation of the preferred-data comprises performing one or more of the following:
presenting a name entry of the one or more name entries as part of the preferred-data recommendation, wherein the name entry is displayed in combination with the preferred-data recommendation;
presenting a confidence indicator associated with a confidence score that quantifies a likelihood that the embedded-name is the preferred-data; and
presenting a preferred-data audio interface element, wherein a selection of the preferred-data audio interface element causes audio playback of the predicted alternative for the one or more name entries.

8. One or more computer-storage media having computer-executable instructions embodied thereon that, when executed by a computing system having a processor and memory, cause the processor to:
access, at a preferred-data management engine, contact data that includes a plurality of contact information entries associated with a contact, wherein the plurality of contact information entries include one or more name entries;
parse the contact data, using a preferred-data computation engine, wherein parsing the contact data comprises programmatically extracting preferred-data from a plurality of preferred-data source objects identified in the contact data; and
communicate, for presentation on a preferred-data interface, the preferred-data as a preferred-data recommendation that is a predicted alternative for the one or more name entries.

9. The media of claim 8, wherein the contact data is retrieved from a plurality of sources based on a contact list of a plurality contacts including the contact, the contact list is provided to trigger retrieving the contact data from the plurality of data sources associated with a plurality of entities.

10. The media of claim 8, wherein parsing the contact data to programmatically extract preferred-data comprises:
accessing an email address or a social media identifier in the contact data as a preferred-data source object;
identifying an embedded-name in the preferred-data source object;
determining that the embedded-name is a substring of the one or more name entries; and
based on determining that the embedded-name is the substring, selecting the embedded-name as the preferred-data.

11. The media of claim 10, wherein identifying the embedded-name in the preferred-data source object is based on identifying one or more known delimiters that precede or follow the embedded-names in the preferred-data source object; and
wherein selecting the embedded name as the preferred-data is further based on processing the embedded-name and the one or more name entries via a name-nickname database that include name-nickname combinations.

12. The media of claim 8, wherein parsing the contact data to programmatically extract preferred-data comprises:
detecting an embedded-name in a preferred-data source object, wherein the preferred-data source object is an audio;
determining the embedded-name in the preferred-data source object is a substring of the one or more name entries; and
based on determining that the embedded-name is a substring, selecting the embedded-name as the preferred-data.

13. The media of claim 8, wherein parsing the contact data comprises performing each of the following parsing operations including:
retrieving the one or more name entries comprising one or more of the following: a first name, last name, middle name, other name, or preferred name;
apply a parsing logic to the preferred-data source object, wherein the preferred-data source object a contact information entry with a likelihood of having an embedded name or data associated with computing an embedded-name;
comparing the embedded-name to a first name, last name, middle name, other name, or preferred name; and
generating confidence score that quantifies a likelihood that the embedded-name is the preferred-data.

14. The media of claim 8, wherein the preferred-data interface is associated with a customer relationship management system, wherein causing presentation of the preferred-data comprises performing one or more of the following:
presenting a name entry of the one or more name entries as part of the preferred-data recommendation, wherein the name entry is displayed in combination with the preferred-data recommendation;
presenting a confidence indicator associated with a confidence score that quantifies a likelihood that the embedded-name is the preferred-data; and
presenting a preferred-data audio interface element, wherein a selection of the preferred-data audio interface element causes audio playback of the predicted alternative for the one or more name entries.

15. A computer-implemented method, the method comprising:
accessing, at a preferred-data management engine, contact data that includes a plurality of contact information entries associated with a contact, wherein the plurality of contact information entries include one or more name entries;
parsing the contact data, using a preferred-data computation engine, wherein parsing the contact data comprises programmatically extracting preferred-data from a plurality of preferred-data source objects identified in the contact data; and
communicating, for presentation on a preferred-data interface, the preferred-data as a preferred-data recommendation that is a predicted alternative for the one or more name entries.

16. The method of claim 15, wherein the contact data is retrieved from a plurality of sources based on a contact list of a plurality contacts including the contact, the contact list is provided to trigger retrieving the contact data from the plurality of data sources associated with a plurality of entities.

17. The method of claim 15, wherein parsing the contact data to programmatically extract preferred-data comprises:
accessing an email address or a social media identifier in the contact data as a preferred-data source object;
identifying an embedded-name in the preferred-data source object;
determining that the embedded-name is a substring of the one or more name entries; and
based on determining that the embedded-name is the substring, selecting the embedded-name as the preferred-data.

18. The method of claim 17, wherein identifying the embedded-name in the preferred-data source object is based on identifying one or more known delimiters that precede or follow the embedded-names in the preferred-data source object; and
wherein selecting the embedded name as the preferred-data is further based on processing the embedded-name and the one or more name entries via a name-nickname database that include name-nickname combinations.

19. The method of claim 15, wherein parsing the contact data to programmatically extract preferred-data comprises:
detecting an embedded-name in a preferred-data source object, wherein the preferred-data source object is an audio;
determining the embedded-name in the preferred-data source object is a substring of the one or more name entries; and
based on determining that the embedded-name is a substring, selecting the embedded-name as the preferred-data.

20. The method of claim 15, wherein parsing the contact data comprises performing each of the following parsing operations including:
retrieving the one or more name entries comprising one or more of the following: a first name, last name, middle name, other name, or preferred name;
apply a parsing logic to the preferred-data source object, wherein the preferred-data source object a contact information entry with a likelihood of having an embedded name or data associated with computing an embedded-name;
comparing the embedded-name to a first name, last name, middle name, other name, or preferred name; and
generating confidence score that quantifies a likelihood that the embedded-name is the preferred-data.
